(19) United States
(12) Patent Application Publication
(10) Pub. No.: US 2018/0139708 A1
(43) Pub. Date: May 17, 2018

(54) INTEGRATED WIRELESS ACCESS DEVICES FOR PROVIDING ACCESS TO CELLULAR AND WIRELESS LOCAL AREA NETWORKS

(71) Applicant: CELLPHONE-MATE, INC., Fremont, CA (US)

(72) Inventor: Hongtao Zhan, Fremont, CA (US)

(21) Appl. No.: 15/812,053

(22) Filed: Nov. 14, 2017

Related U.S. Application Data
(60) Provisional application No. 62/422,533, filed on Nov. 15, 2016.
(60) Provisional application No. 62/522,972, filed on Jun. 21, 2017.

(51) Int. Cl. H04W 52/52; H01Q 1/22; H01Q 1/24

(52) U.S. Cl. CPC H04W 52/52; H04L 12/10; H01Q 1/246; H01Q 1/2291

(57) ABSTRACT

Integrated wireless access devices for providing access to cellular and wireless local area networks are provided herein. In certain configurations, an integrated wireless access device includes a cellular antenna for communicating cellular signals with UE of a cellular network, such as mobile devices. The integrated wireless access device further includes a WLAN access point for providing wireless clients with access to a WLAN network, such as a Wi-Fi network.

### REFERENCE TO RELATED CASES

This application claims the benefit of priority under 35 U.S.C. § 119 of U.S. Provisional Patent Application No. 62/522,972, filed Jun. 21, 2017 and titled “INTEGRATED WIRELESS ACCESS DEVICES FOR PROVIDING ACCESS TO CELLULAR AND WIRELESS LOCAL AREA NETWORKS,” and of U.S. Provisional Patent Application No. 62/422,533, filed Nov. 15, 2016 and titled “APPARATUS AND METHODS FOR TRANSMITTING THE SIGNAL OF A CELLULAR NETWORK AND WIRELESS LOCAL AREA NETWORK,” each of which is herein incorporated by reference in its entirety.

### FIELD

Embodiments of the invention relate to wireless communications.

### BACKGROUND

A cellular network includes base stations for wirelessly communicating with mobile devices located within the network's cells. For example, base stations can transmit signals to mobile devices via a downlink (DL) channel and receive signals from the mobile devices via an uplink (UL) channel. In the case of a cellular network operating using frequency division duplexing (FDD), the downlink and uplink channels are separated in the frequency domain such that the frequency band operates using a pair of frequency channels.

A mobile device may be unable to communicate with any base stations when located in a portion of the cellular network having poor or weak signal strength. For example, the mobile device may be unable to communicate with a particular base station when the mobile device is separated from the base station by a large distance. Additionally, structures such as buildings or mountains can interfere with the transmission and/or reception of signals sent between a mobile device and a base station.

To improve a network's signal strength and/or coverage, a radio frequency (RF) signal booster can be used to amplify signals in the cellular network. For example, the signal booster can be used to amplify or boost signals having frequencies associated with the frequency ranges of the cellular network's uplink and downlink channels.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description of Embodiments” one will understand how the features of this invention provide advantages that include improved communications between access points and mobile stations in a wireless network.

In one aspect, an integrated wireless access device for providing cellular and wireless local area network (WLAN) access is provided. The integrated wireless access device includes an antenna operable to wirelessly communicate with user equipment (UE) to provide access to a cellular network, a housing, and WLAN access point (AP) circuitry within the housing. The WLAN AP circuitry is configured to control wireless communications with one or more wireless clients of a WLAN network.

In some embodiments, the integrated wireless access device further includes an integrated router within the housing and electrically connected to the WLAN AP circuitry.

In a number of embodiments, the housing is configured to receive one or more cables, and the antenna is operable to transmit a cellular downlink signal received from the one or more cables.

In various embodiments, the antenna is configured to receive a cellular uplink signal from the UE and to provide the cellular uplink signal to an external signal booster over the one or more cables. In several embodiments, the WLAN AP circuitry is operable to receive an Internet connection via the one or more cables. In accordance with certain embodiments, the integrated wireless access device further includes a circuit board including the WLAN AP circuitry, and the circuit board includes a hole configured for passage of the one or more cables. According to some embodiments, the integrated wireless access device further includes a power management circuit within the housing and operable to power the WLAN AP circuitry with a DC supply voltage received from the one or more cables. In accordance with a number of embodiments, the one or more cables include an Ethernet cable, and the integrated wireless access device is powered from the Ethernet cable by Power over Ethernet (POE) technology.

In some embodiments, the WLAN AP circuitry is configured to control transmission and reception of Wi-Fi signals.

In various embodiments, the housing includes an interface configured to connect to an external cellular modem, and the WLAN AP circuitry is operable to receive an Internet connection via the external cellular modem.

In several embodiments, the integrated wireless access device further includes an integrated cellular modem within the housing, and the WLAN AP circuitry is operable to receive an Internet connection via the integrated cellular modem.

In a number of embodiments, the antenna is further configured to transmit a cellular downlink signal and to receive a cellular uplink signal.

In accordance with certain embodiments, the antenna is further configured to transmit a WLAN downlink signal and to receive a WLAN uplink signal. In several embodiments, the antenna is a wideband antenna operable over at least a frequency range from 698 MHz to 5.9 GHz.

In several embodiments, the integrated wireless access device further includes a combiner within the housing, and the combiner is operable to combine a cellular signal and a WLAN signal.

In some embodiments, the WLAN AP circuitry is operable over two or more WLAN frequency bands.

In accordance with several embodiments, the integrated wireless access device further includes at least one WLAN antenna, and the at least one WLAN antenna is operable to transmit a WLAN downlink signal and to receive a WLAN uplink signal. In several embodiments, the at least one WLAN antenna includes two or more WLAN antennas operable to provide multiple-input and multiple-output (MIMO) communications.

In a number of embodiments, the integrated wireless access device further includes a shielding structure positioned between the WLAN AP circuitry and the antenna. According to several embodiments, the integrated wireless access device further includes at least one WLAN antenna within the housing, and the antenna is positioned within the housing between the shielding structure and the at least one WLAN antenna.

In various embodiments, the housing includes at least one of holes or grooves to provide heat dissipation by way of air convection.

According to some embodiments, the WLAN AP circuitry includes a data exchange circuit, a power amplifier, a low noise amplifier, and a switch.

In a number of embodiments, the integrated wireless access device further includes signal booster circuitry within the housing and configured to boost a cellular uplink signal received from the antenna to generate a boosted cellular uplink signal. In several embodiments, the antenna is further configured to transmit a boosted cellular downlink signal received from the signal booster circuitry. In accordance with some embodiments, the housing is configured to receive one or more cables, and the signal booster circuity is further configured to send the boosted cellular uplink signal over the one or more cables.

In another aspect, a cellular and WLAN access system is provided. The cellular and WLAN access system includes a base station antenna operable to receive a cellular downlink signal, a signal booster configured to generate a boosted cellular downlink signal by amplifying one or more downlink channels of the cellular downlink signal, and an integrated wireless access device configured to receive the boosted cellular downlink signal over a radio frequency (RF) cable. The integrated wireless access device includes an antenna configured to transmit the boosted cellular downlink signal and to receive a cellular uplink signal, and WLAN AP circuitry configured to control wireless communications over a WLAN network.

In various embodiments, the cellular and WLAN access system further includes a router connected to the integrated wireless access device via an Ethernet cable.

In a number of embodiments, the integrated wireless access device receives power from the Ethernet cable via POE technology.

In some embodiments, the integrated wireless access device is further configured to provide the cellular uplink signal to the signal booster over the RF cable, and the signal booster is further configured to generate a boosted cellular uplink signal by amplifying one or more uplink channels of the cellular uplink signal.

In accordance with various embodiments, the integrated wireless access device further includes at least one WLAN antenna operable to transmit a WLAN transmit signal and to receive a WLAN receive signal.

In another aspect, an integrated wireless access device for providing cellular and WLAN access is provided. The integrated wireless access device includes a housing, an antenna integrated with or within the housing, wherein the antenna is operable to wirelessly communicate with UE of a cellular network, and WLAN AP circuitry within the housing. The WLAN AP circuitry is configured to control wireless communications with one or more wireless clients of a WLAN network.

In a number of embodiments, the integrated wireless access device further includes an integrated router within the housing and connected to the WLAN AP circuitry.

In accordance with several embodiments, the housing is configured to receive one or more cables, and the antenna is operable to transmit a boosted cellular downlink signal received from the one or more cables. In several embodiments, the antenna is configured to receive a cellular uplink signal from the UE and to provide the cellular uplink signal to an external signal booster over the one or more cables. According to various embodiments, the one or more cables include an Ethernet cable configured to electrically connect the WLAN AP circuitry to an Internet connection via an external router. In accordance with some embodiments, the integrated wireless access device further includes a circuit board including the WLAN AP circuitry, and the circuit board includes a hole configured for passage of the one or more cables. In accordance with various embodiments, the integrated wireless access device further includes a power management circuit within the housing and operable to power the WLAN AP circuitry with a DC supply voltage received from the one or more cables. In accordance with a number of embodiments, the one or more cables include an Ethernet cable, and the integrated wireless access device is powered from the Ethernet cable by POE technology.

In accordance with certain embodiments, the WLAN AP circuitry is configured to control communication of Wi-Fi signals.

In several embodiments, the housing includes an interface configured to connect to an external cellular modem, wherein the WLAN AP circuitry is operable to receive an Internet connection via the external cellular modem.

In a number of embodiments, the integrated wireless access device further includes an integrated cellular modem within the housing, and the WLAN AP circuitry is operable to receive an Internet connection via the integrated cellular modem.

In some embodiments, the antenna is further configured to transmit a cellular downlink signal and to receive a cellular uplink signal.

In several embodiments, the antenna is further configured to transmit a WLAN signal and to receive a WLAN signal. In accordance with a number of embodiments, the antenna is a wideband antenna operable over at least a frequency range from 698 MHz to 5.9 GHz.

In various embodiments, the integrated wireless access device further includes a combiner within the housing, and the combiner is operable to combine a cellular signal and a WLAN signal.

In some embodiments, the WLAN AP circuitry is operable over two or more WLAN frequency bands. In several embodiments, the two or more WLAN frequency bands include low band Wi-Fi and high band Wi-Fi.

In several embodiments, the integrated wireless access device further includes at least one WLAN antenna integrated with or within the housing, and the at least one WLAN antenna is operable to transmit a WLAN transmit signal and to receive a WLAN receive signal. According to certain embodiments, the at least one WLAN antenna includes two or more WLAN antennas operable to provide MIMO communications.

In various embodiments, the integrated wireless access device further includes a shielding structure positioned between the WLAN AP circuitry and the antenna. In accordance with some embodiments, the integrated wireless access device further includes at least one WLAN antenna within the housing, and the cellular antenna is positioned between the shielding structure and the at least one WLAN antenna.

In a number of embodiments, the housing includes at least one of holes or grooves to provide heat dissipation by way of air convection.

In several embodiments, the WLAN AP circuitry includes a data exchange circuit, a power amplifier, a low noise amplifier, and a switch.

In various embodiments, the integrated wireless access device further includes signal booster circuitry within the housing and configured to boost a cellular uplink signal received from the antenna to generate a boosted cellular uplink signal. In accordance with some embodiments, the antenna is further configured to transmit a boosted cellular downlink signal received from the signal booster circuitry. According to certain embodiments, the housing is configured to receive one or more cables, and the signal booster circuity is further configured to send the boosted cellular uplink signal over the one or more cables.

In a number of embodiments, the housing is configured for installation in an interior of a building.

In several embodiments, the antenna includes a directional antenna, and the housing is configured for installation on an interior wall of a building.

In various embodiments, the antenna includes an omnidirectional antenna, wherein the housing is configured for installation on an interior wall or ceiling of a building.

In another aspect, a cellular and WLAN access system is provided. The cellular and WLAN access system includes a base station antenna, a signal booster configured to receive a cellular downlink signal from the base station antenna and to generate a boosted cellular downlink signal by amplifying one or more downlink channels of the cellular downlink signal, a cable, and an integrated wireless access device including an antenna configured to transmit the boosted cellular downlink signal, and WLAN AP circuitry configured to control wireless communications over a WLAN network.

In some embodiments, the cellular and WLAN access system further includes an Ethernet cable and a router connected to the WLAN AP circuitry via the Ethernet cable.

In a number of embodiments, the integrated wireless access device receives power from the Ethernet cable via POE technology.

In several embodiments, the antenna is further configured to receive a cellular uplink signal and to provide the cellular uplink signal to the signal booster over the cable. In accordance with some embodiments, the signal booster is further configured to generate a boosted cellular uplink signal by amplifying one or more uplink channels of the cellular uplink signal, and to send the boosted cellular uplink signal to the base station antenna for transmission.

In various embodiments, the WLAN AP circuitry is configured to control communication of Wi-Fi signals.

In a number of embodiments, the integrated wireless access device further includes an interface configured to connect to a cellular modem, wherein the WLAN AP circuitry is operable to receive an Internet connection via the cellular modem.

In several embodiments, the integrated wireless access device further includes an integrated cellular modem, wherein the WLAN AP circuitry is operable to receive an Internet connection via the integrated cellular modem.

In some embodiments, the antenna is further configured to transmit a WLAN signal and to receive a WLAN signal. In accordance with a number of embodiments, the antenna includes a wideband antenna operable over at least a frequency range from 698 MHz to 5.9 GHz.

In various embodiments, the WLAN AP circuitry is operable over two or more WLAN frequency bands. According to a number of embodiments, the two or more WLAN frequency bands include low band Wi-Fi and high band Wi-Fi.

In several embodiments, the integrated wireless access device further includes at least one WLAN antenna operable to transmit a WLAN transmit signal and to receive a WLAN receive signal. In accordance with a number of embodiments, the at least one WLAN antenna includes two or more WLAN antennas operable to provide MIMO communications.

In some embodiments, the WLAN AP circuitry includes a data exchange circuit, a power amplifier, a low noise amplifier, and a switch.

In various embodiments, the integrated wireless access device further includes signal booster circuitry configured to further amplify the boosted cellular downlink signal prior to transmission over the antenna.

In a number of embodiments, the integrated wireless access device is configured for indoor installation in a building. According to several embodiments, the base station antenna is configured for outdoor installation.

In another aspect, an apparatus configured to transmit the signals of a cellular network and wireless local area network is provided. The apparatus includes a housing, an indoor antenna configured to provide a downlink signal from the base station and to receive an uplink signal from the device, at least one antenna configured to transmit a WLAN signal.

In a number of embodiments, the antenna configured to transmit the signal of wireless local area network is included in an AP. In several embodiments, the AP is powered by POE. In accordance with various embodiments, the AP further includes MIMO antennas for use with 2.4 GHz and 5 GHz Wi-Fi signals. According to several embodiments, the AP further includes a printed circuit board including a hole of sufficient size to pass a radio frequency cable and an Ethernet cable. In according with certain embodiments, the apparatus further includes a shielding case configured to reduce or prevent interference between the indoor antenna and the AP.

In various embodiments, the apparatus is configured to be installed in connection with an outdoor antenna via a single hole in a structure.

In some embodiments, the apparatus further includes a signal booster.

In several embodiments, the housing further includes a plurality of holes configured to provide heat dissipation.

In a number of embodiments, the indoor antenna includes an omnidirectional antenna or directional antenna.

In various embodiments, the indoor antenna is configured to connect to a radio frequency cable via a connector. In several embodiments, the apparatus further includes a single complex cable including the radio frequency cable and an Ethernet cable.

In some embodiments, the indoor antenna is configured to receive the downlink signal from a signal booster.

In a number of embodiments, the at least one antenna is configured to transmit the WLAN signal is located under the indoor antenna.

In another aspect, an apparatus configured to transmit the signals of a cellular network and a wireless local area network is provided. The apparatus includes a housing, and an indoor antenna configured to: provide a downlink signal from a base station, receive an uplink signal from a wireless device, and transmit the signal of the wireless local area network.

In several embodiments, the frequency range of the antenna includes 698 MHz to 5.9 GHz.

In some embodiments, the apparatus further includes an access point. In accordance with various embodiments, the access point is configured to receive POE.

In a number of embodiments, the apparatus is configured to be installed in connection with an outdoor antenna via a single hole in a structure.

In several embodiments, the apparatus further includes a signal booster.

In accordance with some embodiments, the housing includes one or more holes configured to provide heat dissipation.

In another aspect, a method of transmitting signals of a cellular network and a wireless local area network is provided. The method includes providing a downlink signal received from a base station, receiving an uplink signal from a wireless device, and concurrently transmitting the signal of wireless local area network and the cellular network.

In various embodiments, the method further includes installing an apparatus implementing the method in a single layout design for indoor signal coverage. In various embodiments, the method further includes drilling a single hole in a ceiling during installation.

In accordance with some embodiments, the method further includes amplifying the downlink signal from base station and the uplink signal from wireless devices.

In a number of embodiments, the method further includes receiving power via POE.

In some embodiments, the wireless local area network is a Wi-Fi network.

In accordance with certain embodiments, the method further includes dissipating the heat of an active circuit via one or more holes in a housing.

In some embodiments, the method further includes connecting a radio frequency cable and an Ethernet cable to the apparatus.

In several embodiments, the method further includes combining the radio frequency cable and the Ethernet cable into a single complex cable.

### BRIEF DESCRIPTION OF THE DRAWINGS

FIG. 1 is a schematic diagram of one embodiment of a cellular and WLAN access system according to one embodiment.

FIG. 2 is a schematic diagram of one embodiment of a cellular and WLAN access system according to another embodiment.

FIG. 3A is a perspective view of an integrated wireless access device with a cover removed, according to one embodiment.

FIG. 3B is a perspective view of an integrated wireless access device with a cover removed, according to another embodiment.

FIG. 4 is a schematic diagram of an integrated wireless access device with a shared cellular and Wi-Fi antenna, according to one embodiment.

FIG. 5 is a schematic diagram of an integrated wireless access device with separate cellular and Wi-Fi antennas, according to one embodiment.

FIG. 6 is a schematic diagram of an integrated wireless access device with integrated signal booster circuitry, according to one embodiment.

FIG. 7 is a schematic diagram of one example of a cellular signal booster system.

FIG. 8 is a schematic diagram of one example of a Wi-Fi access system.

FIG. 9 is a schematic diagram of a cellular and WLAN access system including an integrated wireless access device, according to one embodiment.

FIG. 10 is a schematic diagram of a cellular and WLAN access system including multiple integrated wireless access devices, according to one embodiment.

FIG. 11A is a schematic diagram of a perspective view of another embodiment of an integrated wireless access device.

FIG. 11B is a schematic diagram of a perspective view of the integrated wireless access device of FIG. 11A with a cover removed.

FIG. 12 is a schematic diagram of a cellular and WLAN access system, according to another embodiment.

FIG. 13 is a schematic diagram of a cellular and WLAN access system according to another embodiment.

FIG. 14 is a schematic diagram of a cellular and WLAN access system according to another embodiment.

FIG. 15A is a perspective view of an integrated wireless access device with a cover removed, according to another embodiment.

FIG. 15B is a perspective view of an integrated wireless access device with a cover removed, according to another embodiment.

### DETAILED DESCRIPTION OF EMBODIMENTS

Various aspects of the novel systems, apparatus, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatus, and methods disclosed herein, whether implemented independently of, or combined with, any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

One type of wireless network is a cellular network, in which base stations wirelessly communicate with user equipment (UE) located within the network's cells. The base stations transmit signals to UE via downlink channels of cellular frequency bands and receive signals from the UE via uplink channels of the cellular frequency bands.

Examples of cellular frequency bands include, but are not limited to, Band II, Band IV, Band V, Band XII, and/or Band XIII For instance, mobile devices in a cellular network can operate using Advanced Wireless Services (AWS) (Band IV), Personal Communication Services (PCS) (Band II), Cellular services (Band V), and/or bands associated with Long Term Evolution (LTE), for instance, Band XII, Band XIII, and various other LTE bands. Although specific examples of cellular frequency bands and communication technologies have been described above, the teachings herein are applicable to a wide range of frequency bands and communications standards, including, but not limited to frequency bands associated with 3G (including 3.5G), 4G (including 4.5G and LTE), and 5G technologies as specified by the Third Generation Partnership Project (3GPP).

A wide variety of types of UE can connect to a cellular network. For example, UE can include mobile devices, such as mobile phones (including smartphones), tablets, laptops, and/or wearable electronics. UE can also include certain stationary devices, such as customer premises equipment (CPE).

Another type of wireless network is a wireless local area network (WLAN), which allows wireless clients to wirelessly connect to a local area network. WLANs can operate using various wireless communication techniques, such as spread-spectrum or orthogonal frequency-divisional multiplexing (OFDM). Additionally, WLANs can provide a connection through an access point to the wider Internet, thereby allowing clients to move within a local coverage area while maintaining an Internet connection.

One example of WLANs is Wi-Fi networks as specified by the Institute of Electrical and Electronics Engineers (IEEE) 802.11 wireless communication standards. Examples of Wi-Fi frequency bands include low band Wi-Fi in the 2.4 GHz frequency block and high band Wi-Fi in the 5 GHz frequency block.

A wide variety of types of wireless clients can connect to WLANs. For instance, wireless clients can include certain types of cellular UE that is also WLAN enabled (for instance, Wi-Fi enabled), such as certain mobile phones, tablets, laptops, and/or wearable electronics. Wireless clients can also include other types of WLAN enabled devices, such as desktops, workstations, and/or smart electronics (for instance, consumer electronics, such as televisions).

WLAN networks include access points (APs) that serve to transmit and receive WLAN signals to thereby communicate with wireless clients. For example, an AP of a Wi-Fi network allows Wi-Fi enabled devices to wirelessly connect to a wired network.

An AP connected to a wired network and a set of wireless clients can be referred to as a basic service set (BSS). A BSS has an identifier or BSSID, which can correspond to the media access control (MAC) address of the AP that services the BSS. One type of Wi-Fi BSS is an infrastructure BSS, in which the AP serves as a central hub for communicating with the wireless clients of the BSS. A distribution system (DS) connects two or more APs in an extended service set (ESS). A DS can be wired or wireless and can serve to provide secure roaming for wireless clients.

APs can operate using a variety of encryption or security mechanisms, including, but not limited to, Wired Equivalent Privacy (WEP), Wi-Fi Protected Access (WPA, WPA2), and/or other protocols. Certain APs offer Wi-Fi Protected Setup (WPS) to facilitate adding new wireless clients to an encrypted network.

Integrated wireless access devices for providing access to cellular and wireless local area networks are provided herein. In certain configurations, an integrated wireless access device includes a cellular antenna for communicating cellular signals with UE of a cellular network, such as mobile devices. The integrated wireless access device further includes a WLAN access point for providing wireless clients with access to a WLAN network, such as a Wi-Fi network.

In certain implementations, the integrated wireless access device is implemented as an indoor device that is mountable within and/or attachable to an interior of a building, such as integrated into or on a wall or ceiling. The integrated wireless access device can be relatively more compact and/or have easier installation relative to an implementation with a separate indoor cellular antenna and WLAN access point.

The integrated wireless access device can include and/or be connectable to signal booster circuitry for providing signal amplification or boosting.

In one example, the integrated wireless access device receives a boosted cellular downlink signal from a signal booster over an RF cable, and transmits the boosted cellular downlink signal to UE via the cellular antenna. The cellular antenna also receives a cellular uplink signal from the UE, which the integrated wireless access device can provide to the signal booster via the RF cable. The signal booster can communicate with one or more base stations of the cellular network using a base station antenna. In another example, the integrated wireless access device can further include an integrated signal booster or a portion of a signal booster's circuitry.

In certain implementations, the base station antenna is an outdoor antenna attached to a building, and the integrated wireless access device including the cellular antenna and WLAN access point is indoors to service UE and wireless clients within an interior of the building. Additionally, the signal booster is within the building and connected to the outdoor antenna and the integrated wireless access device via cables.

Accordingly, the integrated wireless access device serves to transmit a boosted RF downlink signal to UE and to receive an RF uplink signal from the UE, thereby providing enhanced cellular coverage, such as coverage indoors. Furthermore, the integrated wireless access device serves as an access point for the WLAN network. Accordingly, both cellular UE and WLAN wireless clients are provided with simultaneous access to both a cellular network and a WLAN network using the integrated wireless access device.

Thus, the teachings herein can be used to integrate an indoor cellular antenna of a cellular signal booster system with a WLAN AP into a common housing.

In certain implementations, the integrated wireless access device communicates cellular signals and WLAN signals using separate antennas.

In other implementations, the integrated wireless access device also uses the cellular antenna to communicate WLAN signals with wireless clients. In such implementations, both cellular signals and WLAN signals can be transmitted and/or received using one or more shared antennas. In one example, the integrated wireless access device includes a wideband antenna operable over a broad frequency range, for instance, over at least frequencies ranging from 698 MHz to 5.9 GHz to provide coverage of a variety of cellular and Wi-Fi bands. Additionally, the integrated wireless access device can include a combiner (for instance, a diplexer or triplexer) for combining cellular and WLAN signals communicated over the wideband antenna.

The cellular antenna can be implemented in a wide variety of ways. In one example, the cellular antenna can be an omnidirectional antenna such that the integrated wireless access device can be installed in a wide variety of locations with enhanced flexibility. In another example, the integrated wireless access device is implemented for mounting into or on a wall, and the cellular antenna is implemented as a directional antenna operable to radiate away from the wall.

In certain implementations, the integrated wireless access device includes multiple antennas. For example, multiple antennas can be used for supporting communications over different frequency ranges and/or bands, for supporting multi-input multiple-output (MIMO) communications, and/or for separately transmitting and receiving signals. Thus, multiple cellular antennas and/or multiple WLAN antennas can be integrated with the integrated wireless access device. For instance, one or more antennas can be included within and/or extend from a housing of the integrated wireless access device.

According to certain implementations, the cellular antenna and the WLAN AP are included within the housing of the integrated wireless access device. For example, the cellular antenna can be enclosed within the housing, and the WLAN AP can include a circuit board including WLAN AP circuitry. Additionally, the integrated wireless access device can include an RF shielding structure used to isolate the circuit board from the cellular antenna to thereby reduce interference.

In certain implementations, the housing (for instance, a cover of the housing) includes holes and/or grooves on the outer surface, thereby providing cooling via air convection.

The WLAN AP can serve as a Wi-Fi access point, for instance, providing single-band and/or dual-band Wi-Fi. In certain implementations, the integrated wireless access device is connected to an external router, for instance, via an Ethernet cable. In other implementations, the integrated wireless access device includes an integrated router.

Providing an integrated router can provide a number of advantages. For example, high frequency WLAN signals, such as high band Wi-Fi signals, can suffer from a relatively large amount of loss when travelling over a long cable. For instance, a cable's loss can be frequency dependent, and rapidly increase with frequency. In contrast, including an integrated router can aid in providing wireless clients with a high performance WLAN network, including at high frequencies, for instance, high band Wi-Fi.

In certain implementations, the integrated wireless access device includes or is connectable to a cellular modem for providing Internet connectivity to the integrated wireless access device when a wired Internet connection is not available. For example, a USB broadband adapter and/or other cellular modem can be connected to and/or integrated into the integrated wireless access device.

The integrated wireless access device can be powered in a variety of ways. In one example, the integrated wireless access device is connected to an external router over an Ethernet cable, and receives power via Power over Ethernet (POE) technology. In another example, a shared DC power and RF cable is connected between the integrated wireless access device and an external signal booster, and the integrated wireless access device receives a DC supply voltage over the shared DC power and RF cable. For instance, the shared DC power and RF cable can include a conductor that carries an RF voltage superimposed on a DC supply voltage. In yet another example, the integrated wireless access device receives power from a dedicated power cable.

For applications associated with a relatively wide coverage area and/or relatively poor network conditions, multiple integrated wireless access devices can be provided. For example, a building can include multiple integrated wireless access devices installed on different floors and/or in different rooms. For applications using multiple integrated wireless access devices, a wireless access controller can be used to manage the WLAN access points associated with the integrated wireless access devices.

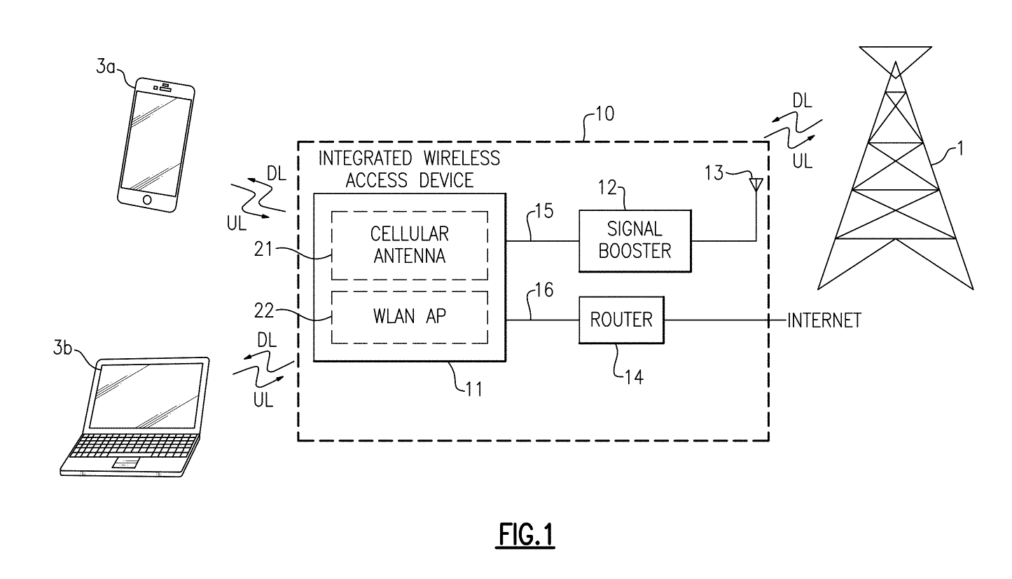

FIG. 1 is a schematic diagram of one embodiment of a cellular and WLAN access system 10 according to one embodiment. The cellular and WLAN access system 10 includes an integrated wireless access device 11, a signal booster 12, a base station antenna 13, a router 14, a signal booster cable 15, and a router cable 16. The integrated wireless access device 11 includes a cellular antenna 21 and a WLAN access point (AP) 22.

As shown in FIG. 1, the router 14 of the cellular and WLAN access system 10 receives a wired Internet connection. The router 14 is connected to the integrated wireless access device 11 via the router cable 16, which can be, for example, an Ethernet cable. In certain implementations, a POE module (for instance, a POE power adapter and/or POE switch) for providing power is included between the integrated wireless access device 11 and the router 14.

The base station antenna 13 is used to wirelessly communicate cellular signals with the base station 1. In certain implementations, the base station antenna 13 corresponds to an outdoor antenna, such as an antenna positioned on a roof or exterior wall of a building. Although illustrated as separate from the signal booster 12, in certain implementations the base station antenna 13 is integrated with the signal booster 12.

The signal booster 12 receives a cellular downlink signal from the base station antenna 13, and amplifies one or more downlink channels of the cellular downlink signal to generate a boosted cellular downlink signal. The signal booster 12 provides the boosted cellular downlink signal to the integrated wireless device 11 via the signal booster cable 15, which can be, for example, an RF cable.

The integrated wireless access device 11 includes the cellular antenna 21, which is used to transmit the boosted cellular downlink signal 21 to cellular UE, which can include, for example, a mobile phone 3a and/or a laptop 3b. The cellular antenna 21 also receives a cellular uplink signal from the UE, which is transmitted to the signal booster 12 via the cable 15. The signal booster 12 amplifies one or more uplink channels of the cellular uplink signal to generate a boosted cellular uplink signal, which is transmitted to the base station 1 via the base station antenna 13.

The integrated wireless access device 11 further includes the WLAN AP 22, which is used to communicate WLAN signals with wireless clients, such as the mobile phone 3a and/or the laptop 3b.

Thus, the integrated wireless access device 11 wirelessly communicates with both UE of a cellular network and wireless clients of a WLAN network. Although FIG. 1 illustrates an example in which both the mobile phone 3a and the laptop 3b can communicate via both the cellular network and the WLAN network, the integrated wireless access device 11 can also communicate with cellular UE that is not WLAN-enabled as well as with wireless clients that are not cellular-enabled.

In certain implementations, the WLAN AP 22 includes one or more WLAN antennas for wirelessly communicating with wireless clients. In other implementations, the cellular antenna 21 is also used by the WLAN AP 22 for WLAN communications. In such implementations, a combiner can be included for combining WLAN signals and cellular signals.

In the illustrated embodiment, the integrated wireless access device 11 allows cellular UE and WLAN wireless clients to simultaneously connect to both a cellular network and a WLAN network via the integrated wireless access device 11. Thus, the integrated wireless access device 11 provides access to both a cellular network and a WLAN network, such as a Wi-Fi network.

Accordingly, the mobile phone 3a and the laptop 3b operate with a cellular connection to the base station 1 via the integrated wireless access device 11 and the signal booster 12 and with an Internet connection via the integrated wireless access device 11 and the router 14. Thus, the integrated wireless access device can communicate cellular and WLAN signals simultaneously, and meet the needs of different users.

Although the integrated wireless access device 11 provides simultaneous cellular and WLAN access, user devices can access the cellular network and/or WLAN as desired. In one example, at a first time instance the mobile phone 3a utilizes the cellular network but not the WLAN network, while the laptop 3b utilizes the WLAN network but not the cellular network. In another example, at a second time instance mobile phone 3a utilizes the WLAN network but not the cellular network, while the laptop 3b utilizes both the WLAN network and the cellular network.

Although FIG. 1 illustrates an example with two wireless devices and one base station, a cellular and WLAN access system can operate with base stations and/or wireless devices of other numbers and/or types. For instance, wireless devices can include mobile phones, tablets, laptops, wearable electronics (for instance, smart watches), desktop computers, televisions, and/or other types of devices suitable for use in a wireless network.

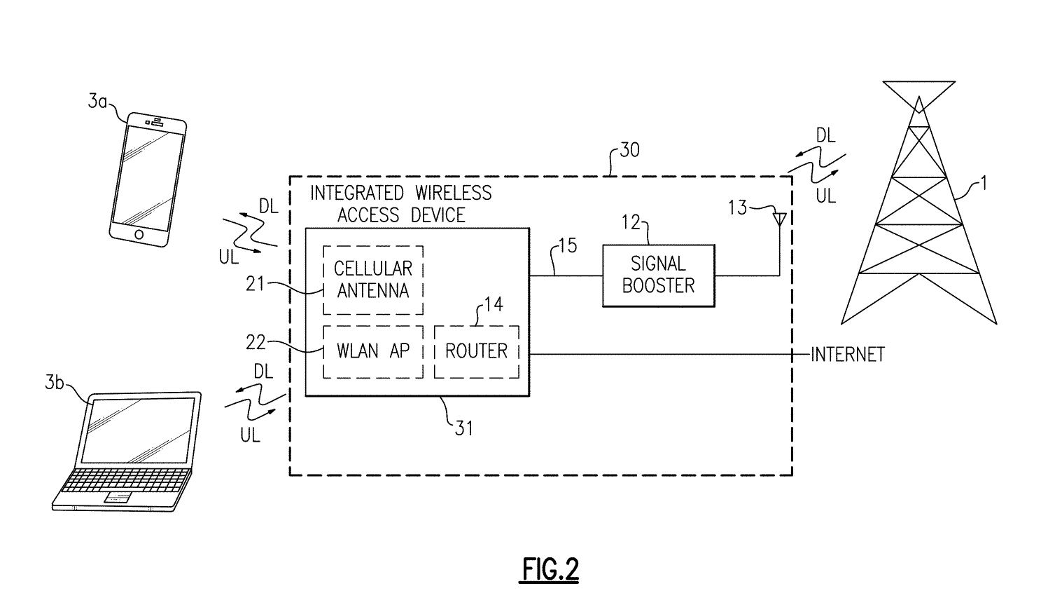

FIG. 2 is a schematic diagram of one embodiment of a cellular and WLAN access system 30 according to another embodiment. The cellular and WLAN access system 30 of FIG. 2 is similar to the cellular and WLAN access system 10 of FIG. 1, except that the cellular and WLAN access system 30 includes an integrated wireless access device 31 that further includes the router 14. The router 14 receives a wired Internet connection, in this embodiment.

Integrating a router into an integrated wireless access device can provide a number of advantages. For example, high frequency WLAN signals, such as high band Wi-Fi signals, can suffer from a relatively large amount of loss when travelling over a long cable, such as a cable of 30 feet or more. For instance, a cable's loss can be frequency dependent, and rapidly increase with frequency.

Thus, integrating the router 14 into the integrated wireless access device 31 provides the mobile phone 3a, the laptop 3b, and/or other wireless clients with a high performance WLAN network, including at high frequencies, for instance, high band Wi-Fi in the 5 GHz frequency block.

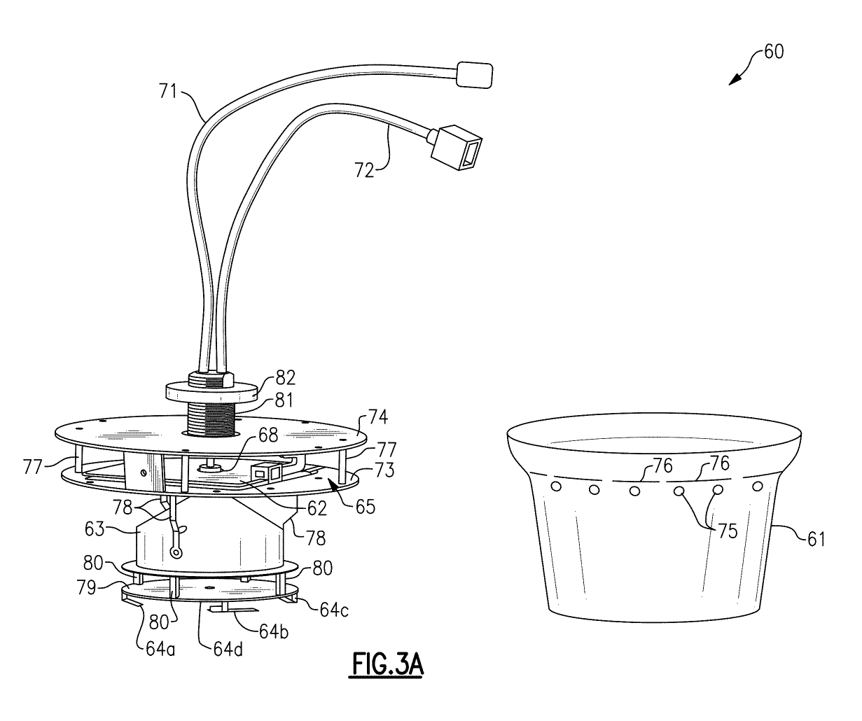

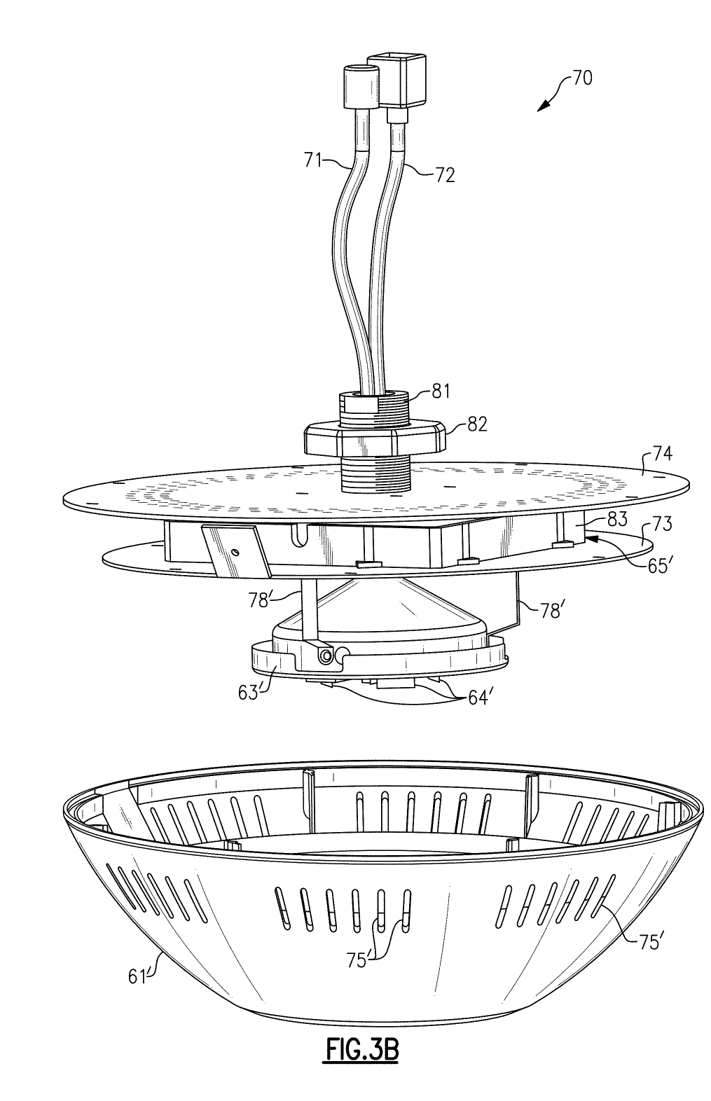

FIG. 3A is a perspective view of an integrated wireless access device 60 with a cover 61 removed, according to one embodiment.

The integrated wireless access device 60 includes a cover 61, a circuit board 62, a cellular antenna 63, WLAN antennas 64a-64d (four, in this example), a shielding structure 65, cellular antenna supports 78, an antenna board 79, antenna spacers 80, a threaded tube 81, and a fastener 82. The shielding structure 65 includes a first shielding plate 73, a second shielding plate 74, and shielding plate spacers 77.

Although one embodiment of an integrated wireless access device is shown in FIG. 3A, the teachings herein are applicable to integrated wireless access devices implemented in a wide variety of ways. For instance, integrated wireless access devices can be implemented with housings of different shapes and/or sizes, with cellular and/or WLAN antennas of different numbers and/or types (for instance, omnidirectional, directional, etc.), with different implementations of circuitry, with different implementations of wiring, and/or in a wide variety of other ways.

In the illustrated embodiment, the shielding plate 74 and the cover 61 serve as a housing to the integrated wireless access device 60. Additionally, certain components of the integrated wireless access device 60, such as the circuit board 62, the cellular antenna 63, and the WLAN antennas 64a-64d are within the housing. Although FIG. 3A illustrates an embodiment in which the cellular antenna 63 and the WLAN antennas 64a-64d are within the housing, the teachings herein are applicable to configurations in which one or more antennas are integrated with the housing in other ways. For example, one or more antennas can extend from the housing rather than reside within the housing. In another embodiment, an integrated wireless access device includes at least one port for providing a user an option to connect one or more optional external antennas.

The circuit board 62 includes WLAN AP circuitry, which operates in combination with the WLAN antennas 64a-64d to communicate with wireless clients of a WLAN network. The WLAN AP circuitry can be implemented in accordance with any of the embodiments herein. In another embodiment, the circuit board 62 also includes a router, cellular signal booster circuitry, and/or power management circuitry.

In the illustrated embodiment, the cellular antenna 63 is secured to the shielding structure 65 by the cellular antenna supports 78. Additionally, the antenna board 79 is spaced apart from the cellular antenna 63 by the antenna spacers 80. Additionally, the WLAN antennas 64a-64d are attached to the antenna board 79.

Placement of the WLAN antennas 64a-64d can impact wireless communication of WLAN signals. For example, placement of multiple WLAN antennas beneath the cellular antenna 63 can aid in providing a robust radiation pattern and spatial diversity for MIMO communications. Although an example with four WLAN antennas is shown, more or fewer WLAN antennas can be included and/or WLAN antennas of different placements and/or types can be used. In another example, WLAN antennas are omitted in favor of using a shared antenna for cellular and WLAN communications. Accordingly, other implementations are possible.

With continuing reference to FIG. 3A, the cellular antenna 63 communicates with cellular UE of a cellular network. In the illustrated embodiment, the cellular antenna 63 is omnidirectional, thereby providing robust cellular communications when installed in a wide variety of locations.

In the illustrated embodiment, the integrated wireless access device 60 receives an RF cable 71 and an Ethernet cable 72. The RF cable 71 can be coupled to an external signal booster, thereby electrically connecting the cellular antenna 80 to the external signal booster. Thus, the RF cable 71 can be used for receiving a boosted cellular downlink signals from the external signal booster and for sending cellular uplink signals to the external signal booster for amplification. In certain implementations, the Ethernet cable 72 is coupled to a router, thereby electrically connecting the WLAN AP circuitry on the circuit board 62 to the router.

As shown in FIG. 3A, the circuit board 62 includes a hole 68, which is positioned in about the center of the circuit board 62, in this example. Including the hole 68 permits passage of wires and/or fasteners, such that the circuit board 62 is compactly stackable together with the cellular antenna 63. For example, conductors or wires associated with the RF cable 71 and Ethernet cable 72 can pass through the threaded tube 81 and the circuit board hole 68 to connect internal circuitry and components of the integrated wireless access device 60 to external cable interfaces or connectors.

Although an example with a separate RF cable 71 and Ethernet cable 72 is shown, an integrated wireless access device can operate using other numbers of cables and/or using cables of other types. In certain implementations an integrated wireless access device is configured to operate using a single complex cable.

In the illustrated embodiment, the first shielding plate 73 and the second shielding plate 74 are spaced apart from one another by the shielding plate spacers 77 to form a cavity. Additionally, the circuit board 62 is placed within the cavity of the shielding structure 65.

The shielding structure 65 aids in isolating the circuit board 62 including the WLAN AP circuitry from the cellular antenna 63. For example, the shielding structure 65 is operable to shield or block spurious signals (for instance, harmonics) associated with low band Wi-Fi and/or other WLAN signal(s) from interfering with cellular communications.

For example, 2.4 GHz Wi-Fi can be associated with some spurious signals with low frequency. Such spurious signals are typically relatively weak, and can be ignored for a stand-alone Wi-Fi access point.

However, such spurious signals can hinder operation of an integrated wireless access device without sufficient shielding and/or other isolation. For example, in an implementation in which the shielding structure 65 or other suitable shielding structure is omitted, spurious signals arising from 2.4 GHz Wi-Fi may reach an external signal booster via the cellular antenna 63 and RF cable 71, and subsequently be amplified. Such amplified spurious signals can interfere with cellular communications and/or operation of the signal booster. Thus, including the shielding structure 65 and/or other shielding or isolation can aid in integrating WLAN AP circuitry into an integrated wireless access device with reduced signaling interference.

In certain implementations, the integrated wireless access device 60 is implemented with one or more heat dissipation mechanisms. For instance, cooling of the integrated wireless access device can be beneficial, particularly in embodiments in which a shielding structure is included. In one example, the cover 61 includes at least one of holes 75 or grooves 76 to provide heat dissipation by way of air convection.

The integrated wireless access device 60 can receive power in a variety of ways. In one example, the integrated wireless access device 60 is powered by the Ethernet cable 72 by way of POE technology. For instance, a POE module, such as a POE power adapter and/or POE switch, can be included between the Ethernet cable 72 and a router. In another example, the RF cable 71 also carries a DC supply voltage, and thus corresponds to a shared DC power and RF cable. For instance, the cable 71 can include a conductor that carries an RF voltage superimposed on a DC supply voltage. In yet another example, the integrated wireless access device 60 receives power from a dedicated power cable.

The integrated wireless access device 60 can be installed in a variety of types of buildings, such as homes, offices, commercial premises, factories, garages, barns, and/or any other suitable building. In the illustrated embodiment, the fastener 82 can be used to secure the integrated wireless access device 60 to a roof or wall. However, the teachings herein are applicable to devices installed in other ways. For example, an integrated wireless access device can be installed using any suitable mount, adhesive, and/or fastener.

FIG. 3B is a perspective view of an integrated wireless access device 70 with a cover 61′ removed, according to another embodiment.

The integrated wireless access device 70 includes a cover 61′, a shielding structure 65′, a cellular antenna 63′, WLAN antennas 64′ (four, in this example), cellular antenna supports 78′, a threaded tube 81, and a fastener 82. The shielding structure 65 includes a first shielding plate 73, a second shielding plate 74, and a shielding enclosure 83, which surrounds a circuit board of the integrated wireless access device 70. Thus, the shielding structure 65′ encloses the circuit board. The circuit board can be implemented with WLAN AP circuitry in accordance with any of the teachings herein. As shown in FIG. 3B, the cover 61′ includes grooves 75′.

In the illustrated embodiment, the circuit board is placed in the shielding structure 65′. Additionally, the WLAN antennas 64′ are attached to (for instance, embedded in) the cellular antenna 63′. Additional details of the integrated wireless access device 70 can be as described above with respect to the integrated wireless access device 60 of FIG. 3A.

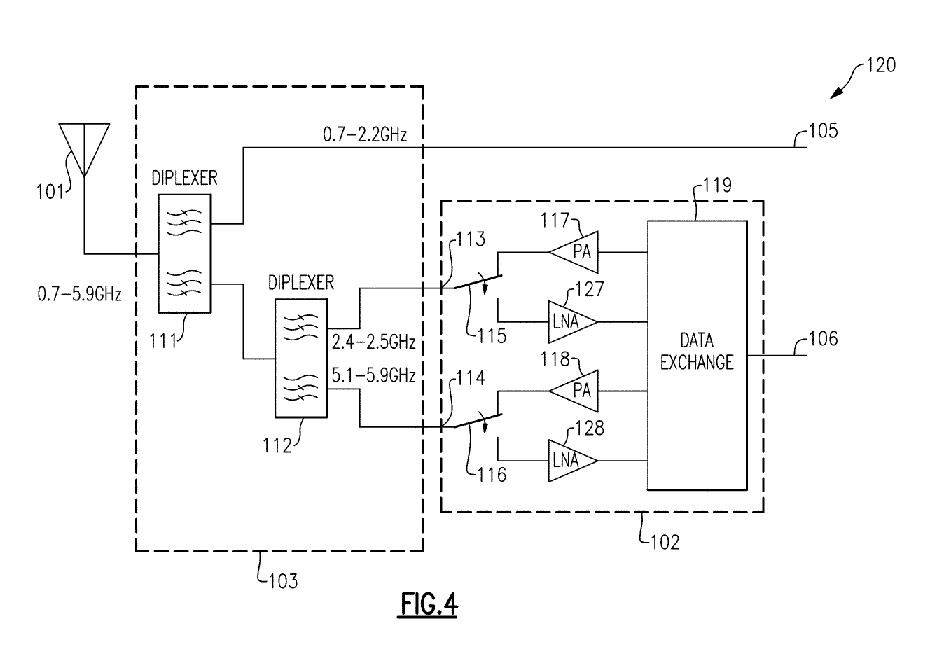

FIG. 4 is a schematic diagram of an integrated wireless access device 120 with a shared cellular and Wi-Fi antenna 101, according to one embodiment. The integrated wireless access device 120 includes a shared cellular and Wi-Fi antenna 101, Wi-Fi AP circuitry 102, and a combiner 103.

As shown in FIG. 4, the Wi-Fi AP circuitry 102 includes a Wi-Fi low band switch 115, a Wi-Fi high band switch 116, a Wi-Fi low band power amplifier (PA) 117, a Wi-Fi high band PA 118, a Wi-Fi low band low noise amplifier (LNA) 127, a Wi-Fi high band LNA 128, and a data exchange circuit 119. Additionally, the combiner 103 includes a cellular/Wi-Fi diplexer 111 and a Wi-Fi high band and low band diplexer 112.

Although one example of an integrated wireless access device is shown in FIG. 4, the teachings herein are applicable to devices implemented in a wide variety of ways. For example, an integrated wireless access device can include antennas, combiners, and/or Wi-Fi AP circuitry implemented in a wide variety of ways. Furthermore, in certain implementations, a combiner is omitted in favor of communicating cellular and WLAN signals using separate antennas.

The illustrated embodiment operates with a single spatial stream. However, the teachings herein are also applicable to implementations operating with multiple spatial streams, such as implementations using MIMO for cellular and/or WLAN communications.

In this example, a first antenna port or terminal 113 of the Wi-Fi AP circuitry 102 is used for transmitting and receiving a 2.4 GHz Wi-Fi signal. Additionally, a second antenna port 114 of the Wi-Fi AP circuitry 102 is used for transmitting and receiving a 5 GHz Wi-Fi signal. The Wi-Fi high band and low band diplexer 112 operates to combine the 2.4 GHz Wi-Fi signal and the 5 GHz Wi-Fi signal, which in turn are combined with a 0.7-2.2 GHz cellular signal using the cellular/Wi-Fi diplexer 111. In certain implementations, a first cable 105 is used to connect the integrated wireless access device to an external signal booster, and a second cable 106 is used to connect the Wi-Fi AP circuitry 102 to the Internet.

In the illustrated embodiment, the shared cellular and Wi-Fi antenna 101 is a wideband antenna operable over a broad frequency range, for instance, over at least frequencies ranging from 698 MHz to 5.9 GHz to provide coverage of a variety of cellular and Wi-Fi bands.

Although specific examples of frequency ranges and bands have been described, the teachings herein are applicable to cellular and WLAN signals of a wide variety of types and frequency ranges. Accordingly, other implementations are possible.

Although one embodiment of an integrated wireless access device is shown in FIG. 4, the teachings herein are applicable to integrated wireless access devices implemented in a wide variety of ways.

For instance, different implementations of antennas, combiners, and/or WLAN AP circuitry can be used. In a first example, multiple antennas are used for an integrated wireless access device. In a second example, a different implementation of a combiner is used, such as a triplexer for combining a cellular signal, a low band Wi-Fi signal, and a high band Wi-Fi signal. In a third example, a combiner is omitted. In a fourth example, a WLAN AP includes a different implementation of circuitry. Accordingly, other implementations are possible.

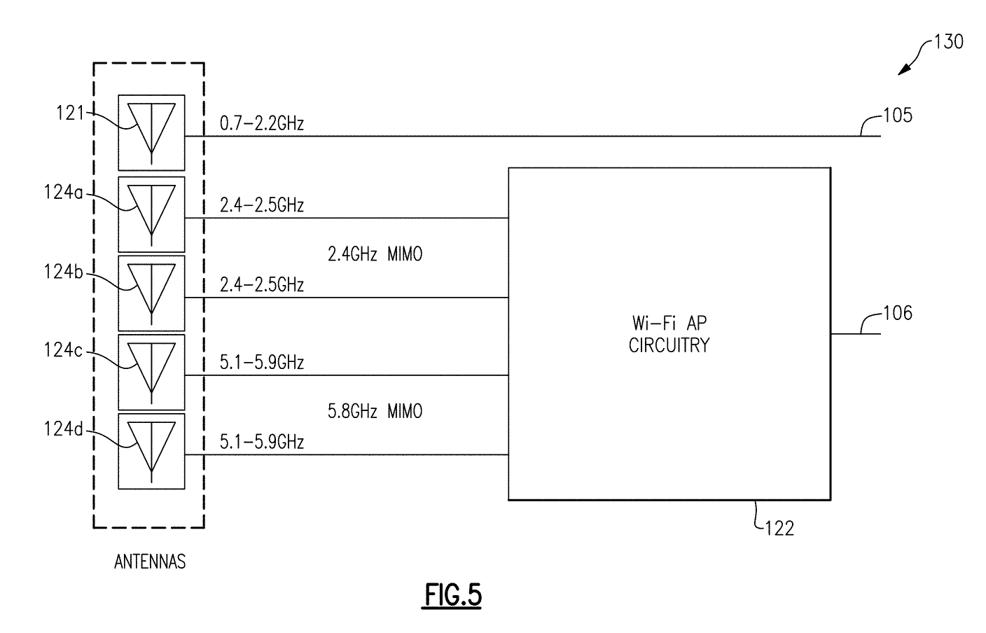

FIG. 5 is a schematic diagram of an integrated wireless access device 130 with separate cellular and Wi-Fi antennas, according to one embodiment.

The integrated wireless access device 130 includes a cellular antenna 121, Wi-Fi AP circuitry 122, and Wi-Fi antennas 124a-124d. The illustrated embodiment supports dual band Wi-Fi in which each Wi-Fi band operates with two spatial streams to provide diversity. For example, Wi-Fi antennas 124a and 124b operate to transmit and receive two low band Wi-Fi data streams to provide low band Wi-Fi MIMO. Additionally, Wi-Fi antennas 124c and 124d operate to transmit and receive two high band Wi-Fi data streams to provide high band Wi-Fi MIMO.

Although one embodiment of an integrated wireless access device is shown in FIG. 5, the teachings herein are applicable to integrated wireless access devices implemented in a wide variety of ways.

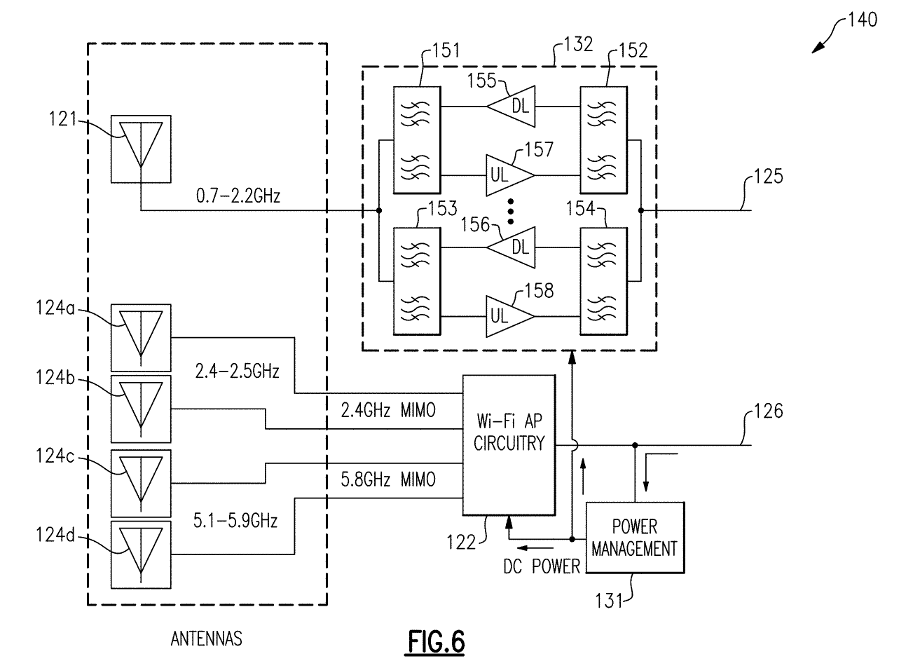

FIG. 6 is a schematic diagram of an integrated wireless access device 140 with integrated signal booster circuitry, according to one embodiment.

The integrated wireless access device 140 of FIG. 6 is similar to the integrated wireless access device 130 of FIG. 5, except that the integrated wireless access device 140 further includes a power management circuit 131 and signal booster circuitry 132.

The power management circuit 131 receives power from a cable 126, and provides DC power to the Wi-Fi AP circuitry 122 and the signal booster circuitry 132. In one example, the cable 126 can correspond to an Ethernet cable, and the power management circuit 131 can be used to generate a DC supply voltage for the Wi-Fi AP circuitry 122 and signal booster circuitry 132 using POE technology (for instance, POE technology for converting 48V DC received from the cable 126 to 5-12V DC). In other implementations, the power management circuit 131 can receive power from a different cable than used for WLAN signaling, such as a dedicated power cable or a shared DC power and RF cable.

In the illustrated embodiment, the integrated wireless access device 140 further includes the signal booster circuitry 132. The signal booster circuitry 132 receives a cellular uplink signal from the cellular antenna 121, and amplifies one or more uplink channels of the cellular uplink signal to generate a boosted cellular uplink signal for transmission via an RF cable 125. The signal booster circuitry 132 further receives a cellular downlink signal from the RF cable 125, and amplifies one or more downlink channels of the cellular downlink signal to generate a boosted cellular downlink signal for transmission via the cellular antenna 121.

In the illustrated embodiment, the signal booster circuitry 132 includes a first frequency multiplexer 151, a second frequency multiplexer 152, a third frequency multiplexer 153, a fourth frequency multiplexer 154, a first downlink amplification circuit 155, a second downlink amplification circuit 156, a first uplink amplification circuit 157, and a second uplink amplification circuit 158. The first frequency multiplexer 151, the second frequency multiplexer 152, the first downlink amplification circuit 155, and the first uplink amplification circuit 157 operate to provide bidirectional signal boosting to cellular signals associated with a first frequency band (for example, a first 3GPP frequency band). Additionally, the third multiplexer 153, the fourth frequency multiplexer 154, the second downlink amplification circuit 156, and the second uplink amplification circuit 158 operate to provide bidirectional signal boosting to cellular signals associated with a second frequency band (for example, a second 3GPP frequency band).

Although an example of signal booster circuitry for boosting two frequency bands is shown, the signal booster circuitry can be modified to provide signal booster for more or fewer frequency bands. For example, more or fewer frequency multiplexers, uplink amplification circuits, and downlink amplifications circuits can be included to provide signal boosting to a desired number of frequency bands.

Furthermore, although one implementation of signal booster circuitry is shown in FIG. 6, signal booster circuitry can be implemented in a wide variety of ways. Examples of circuitry and components for signal booster circuitry include, but are not limited to, amplifiers (for instance, LNAs, PAs, variable gain amplifiers (VGAs), programmable gain amplifiers (PGAs), and/or other amplification circuits), filters (for instance, surface acoustic wave (SAW) filters, bulk acoustic wave (BAW) filters, film bulk acoustic resonator (FBAR) filters, active circuit filters, passive circuit filters, and/or other filtering structures), frequency multiplexers (for instance, duplexers, circulators, diplexers, triplexers, or other multiplexing structures), switches, impedance matching circuitry, attenuators (for instance, digital attenuators such as digital step attenuators (DSAs) and/or analog attenuators such as voltage variable attenuators (VVAs)), detectors, monitors, couplers, and/or control circuitry.

The integrated wireless access device 140 of FIG. 6 illustrates one example of an integrated wireless access device with an integrated signal booster or a portion of a signal booster's circuitry.

In certain implementations, the RF cable 125 is connected to a base station antenna, such as outdoor antenna in communication with one or more cellular base stations. However other configurations are possible. For example, in another implementation, the RF cable 125 is connected to an external signal booster for further boosting of signals, such that the external signal booster and the signal booster circuitry 132 operate in combination to provide a total amount of boosting.

For example, in very high gain applications associated with very poor network conditions and/or very large coverage areas, 80 dB or more of gain may be needed. However, such high gain signal booster circuitry may be too large, too noisy, and/or dissipate too much heat for full integration into an integrated wireless access device. In such applications, an external signal booster can be used in combination with the signal booster circuitry of an integrated wireless access device to achieve a total desired gain.

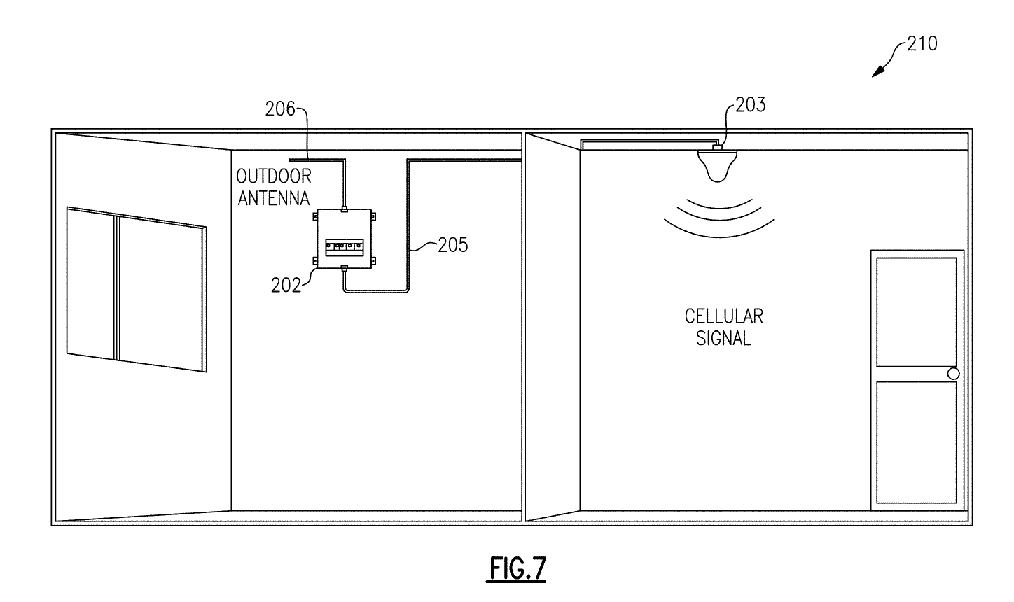

FIG. 7 is a schematic diagram of one example of a cellular signal booster system 210. The cellular signal booster system 210 includes a signal booster 202, an indoor cellular antenna 203, an RF cable 205, and an outdoor antenna cable 206, which connects to an outdoor antenna. The cellular signal booster system 210 provides indoor coverage of a cellular network to mobile phones and other cellular UE, but does not provide Wi-Fi network coverage.

FIG. 8 is a schematic diagram of one example of a Wi-Fi access system 230. The Wi-Fi AP system 230 includes Wi-Fi AP 213, an Internet cable 207, a router 220, an access controller 221, a POE module 222, and Ethernet cables 223. In this example, POE module 222 can be, for example, a POE power adapter and/or POE switch for powering the Wi-Fi AP 213 via POE technology. The Wi-Fi access system 230 provides indoor coverage of a Wi-Fi network to Wi-Fi enabled devices, but does not provide cellular network coverage.

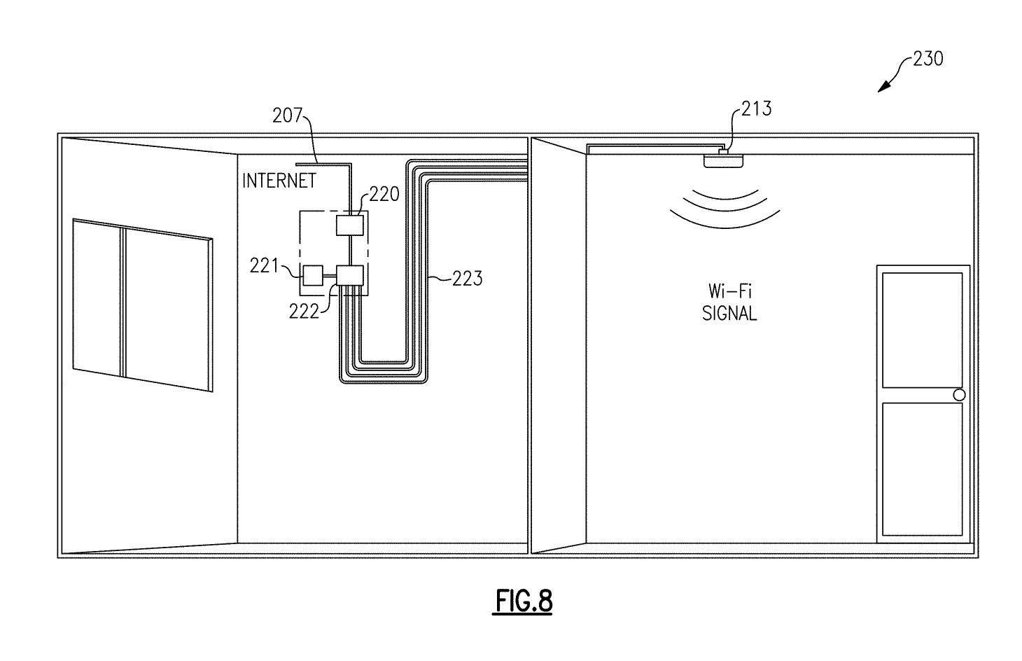

FIG. 9 is a schematic diagram of a cellular and WLAN access system 240 including an integrated wireless access device 233, according to one embodiment. The cellular and WLAN access system 240 includes a signal booster 202, an RF cable 205, an outdoor antenna cable 206, an Internet cable 207, a router 220, an access controller 221, a POE module 222, Ethernet cables 223, and an integrated wireless access device 233, which can be implemented in accordance with one or more features of the present disclosure. In certain implementations, the integrated wireless access device 233 includes an omnidirectional cellular antenna.

As shown in FIG. 9, cellular and Wi-Fi network coverage is provided without needing to install a separate indoor cellular antenna (for example, indoor cellular antenna 203 of FIG. 7) and Wi-Fi AP (for example, Wi-Fi AP 213 of FIG. 8). Rather, in this embodiment, the RF cable 205 and one of the Ethernet cables 223 can be provided to the integrated wireless access device 233 to thereby connect the integrated wireless access device 233 to the signal booster 202 and to the Internet.

Accordingly, a user can install the integrated wireless access device 233 to provide simultaneous Wi-Fi network coverage and cellular network coverage to indoor users.

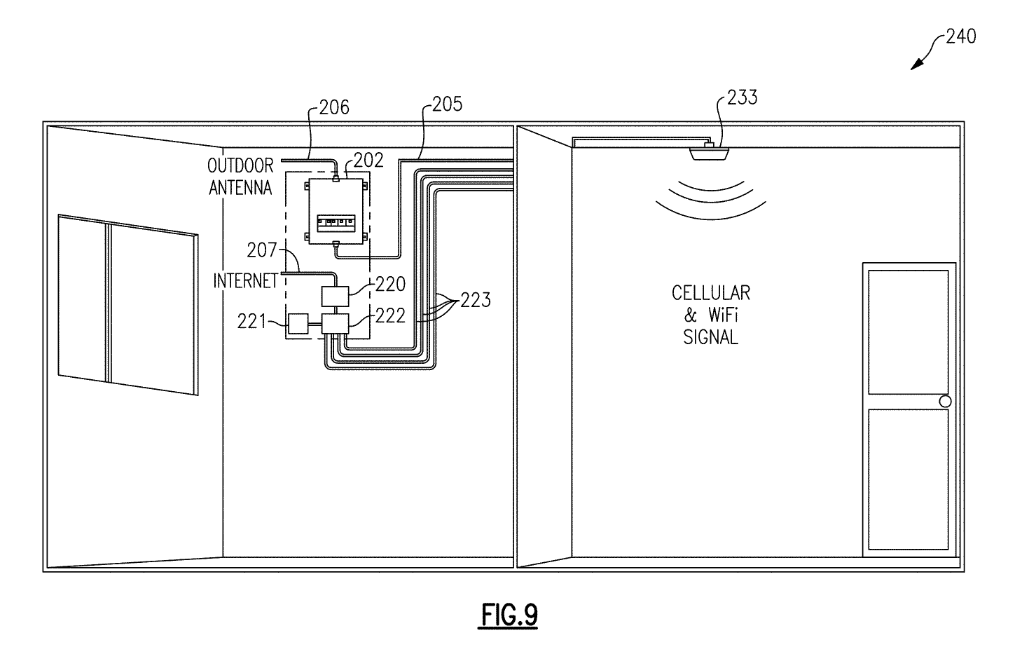

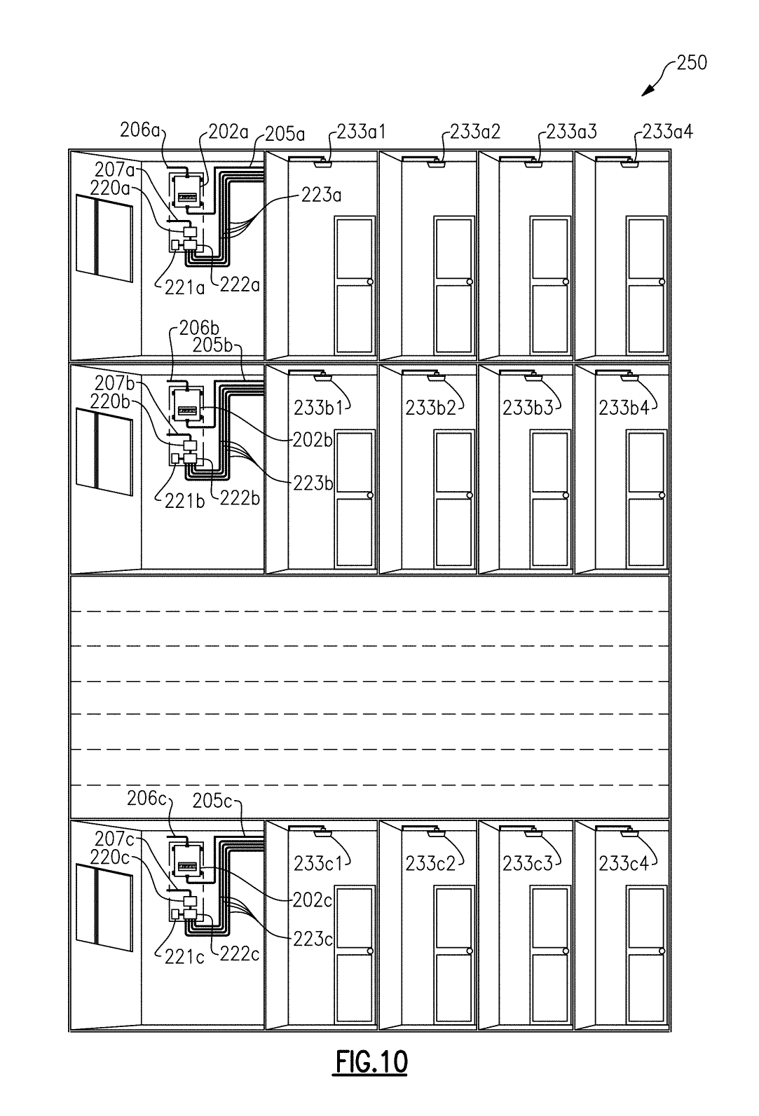

FIG. 10 is a schematic diagram of a cellular and WLAN access system 250 including multiple integrated wireless access devices, according to one embodiment.

The cellular and WLAN access system 250 includes a first signal booster 202a, a first RF cable 205a, a first outdoor antenna cable 206a, a first Internet cable 207a, a first router 220a, a first access controller 221a, a first POE module 222a, a first group of Ethernet cables 223a, and integrated wireless access devices 233a1-233a4 installed on one floor of a building. Additionally, the cellular and WLAN access system 250 includes a second signal booster 202b, a second RF cable 205b, a second outdoor antenna cable 206b, a second Internet cable 207b, a second router 220b, a second access controller 221b, a second POE module 222b, a second group of Ethernet cables 223b, and integrated wireless access devices 233b1-233b4 installed on another floor of a building. Furthermore, the cellular and WLAN access system 250 includes a third signal booster 202c, a third RF cable 205c, a third outdoor antenna cable 206c, a third Internet cable 207c, a third router 220c, a third access controller 221c, a third POE module 222c, a third group of Ethernet cables 223c, and integrated wireless access devices 233c1-233c4 installed on yet another floor of a building.

Thus, in the embodiment shown in FIG. 10, a number of the integrated wireless access devices are deployed in different rooms and/or floors of a building. Although FIG. 10 illustrates an embodiment in which components are replicated on each floor of the building, in other implementations, one or more components are shared across floors.

When many integrated wireless access devices 233 are deployed in a building, it can be advantageous to power up the devices via the POE modules and manage all the Wi-Fi APs associated with the integrated wireless access devices via one or more wireless access controllers. For example, a wireless access controller can manage hundreds of Wi-Fi APs, and can be easy to operate for users.

In this embodiment, the integrated wireless access devices connect first to a corresponding POE module, which provides power, and thereafter to a corresponding router for access to the Internet.

The cellular and WLAN access system 250 can be relatively easy to install relative to an implementation using separate cellular signal booster systems (for instance, multiple instantiations of the cellular signal booster system 210 of FIG. 7) and separate Wi-Fi access systems (for instance, multiple instantiations of the Wi-Fi access system 230 of FIG. 8). For example, at time of installation, a single design layout can be used for installing the integrated wireless access devices, as opposed to an iterative or multiple layout designs. Furthermore, multiple instantiations of the signal booster system 210 of FIG. 7 and the Wi-Fi access system 230 of FIG. 8 can be avoided.

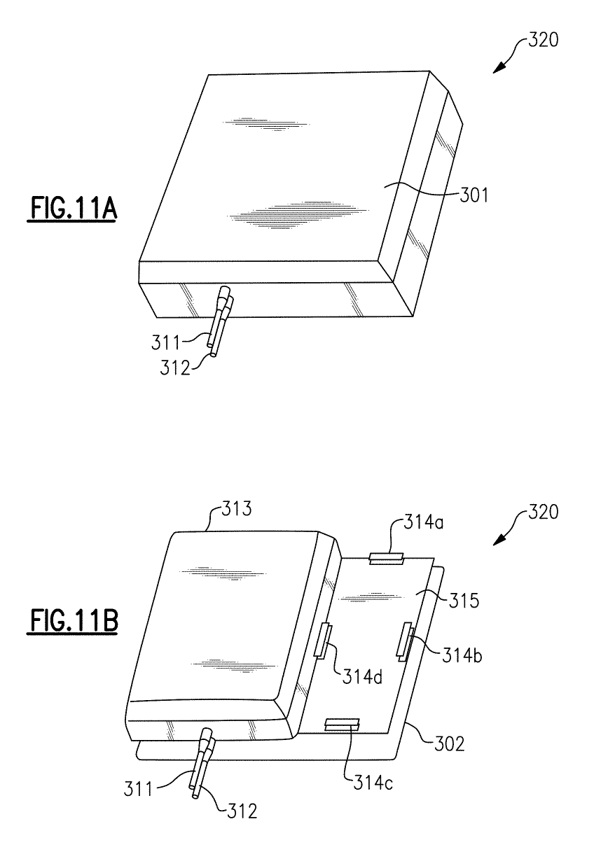

FIG. 11A is a schematic diagram of a perspective view of another embodiment of an integrated wireless access device 320. FIG. 11B is a schematic diagram of a perspective view of the integrated wireless access device of FIG. 11A with a cover 301 removed. The integrated wireless access device 320 includes a housing cover 301, a housing base 302, a directional cellular antenna 313, and WLAN antennas 314a-314d attached to an antenna board 315. Although not visible in FIGS. 11A and 11B, the integrated wireless access device 320 further includes WLAN AP circuitry, which is shielded and positioned between the antennas and the housing base 302.

In the illustrated embodiment, the integrated wireless access device 320 is connectable to an external signal booster via a signal booster cable 311 and to an external router via a router cable 312. However, the teachings herein are also applicable to devices including integrated signal booster circuitry and/or an integrated router.

The integrated wireless access device 320 can be integrated in or mounted to a wall, and provides directional network coverage.

Although one embodiment of an integrated wireless access device is shown in FIGS. 11A and 11B, the teachings herein are applicable to integrated wireless access devices implemented in a wide variety of ways. For instance, integrated wireless access devices can be implemented with housings of different shapes and/or sizes, with cellular and/or WLAN antennas of different numbers and/or, with different implementations of circuitry, with different implementations of wiring, and/or in a wide variety of other ways.

In the illustrated embodiment, the housing cover 301 and the housing base 302 serve as a housing to the integrated wireless access device 320. Additionally, certain components of the integrated wireless access device 320, such as the cellular antenna 313 and the WLAN antennas 314a-314d are within the housing. Although FIGS. 11A and 11B illustrate an embodiment in which the cellular antenna 313 and the WLAN antennas 314a-314d are within the housing, the teachings herein are also applicable to configurations in which one or more antennas are integrated with housing in other ways.

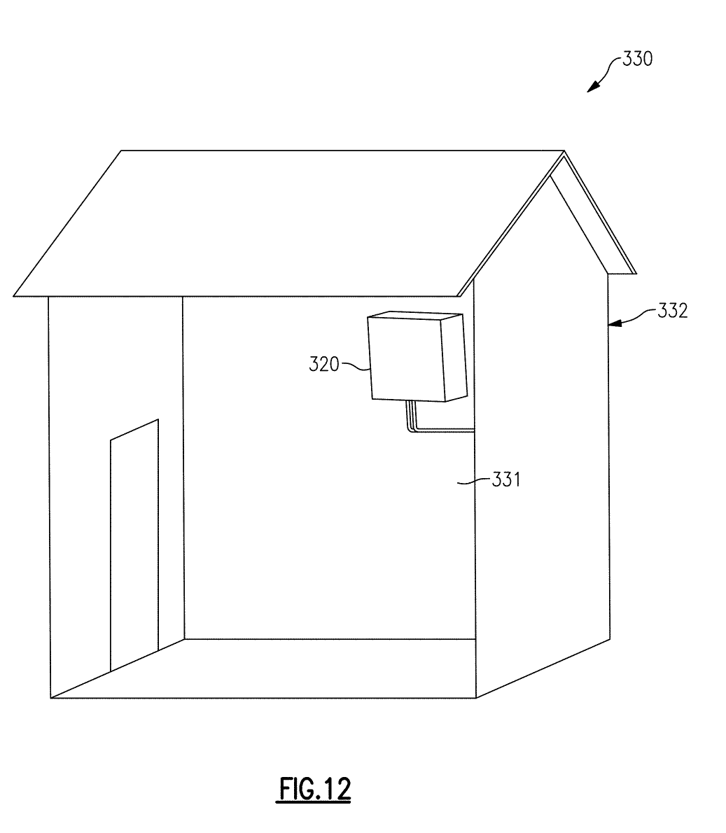

FIG. 12 is a schematic diagram of a cellular and WLAN access system 330, according to another embodiment. The cellular and WLAN access system 330 includes the integrated wireless access device 320, which has been mounted to an interior wall 331 of a building 332. FIG. 12 illustrates one example installation of the integrated wireless access device 320 of FIGS. 11A and 11B.

FIG. 13 is a schematic diagram of a cellular and WLAN access system 410 according to another embodiment. The cellular and WLAN access system 410 includes a signal booster 12, a base station antenna 13, an RF cable 15, an integrated wireless access device 400, and a cellular modem 405. The integrated wireless access device 400 includes a cellular antenna 401, WLAN AP circuitry 402, WLAN antennas 403a-403d, and an integrated router 404.

Integrating the router 404 into the integrated wireless access device 400 can provide a number of advantages. For example, high frequency WLAN signals, such as high band Wi-Fi signals, can suffer from a relatively large amount of loss when travelling over a long cable. For instance, a cable's loss can be frequency dependent, and rapidly increase with frequency. By integrating the router 404 into the integrated wireless access device 400, operation of the WLAN network, particular at high frequencies, can be enhanced. In the illustrated example, the integrated router 404 receives a wired Internet connection via a wide area network (WAN) port.

The illustrated integrated wireless access device 400 includes the WLAN AP circuitry 402, which connects to the Internet via the integrated router 404. In this embodiment, the integrated router 404 is connectable both to a wired Internet connection and to a wireless Internet connection by way of the cellular modem 405. In this example, the wired Internet connection is received over a WAN port, and the wireless Internet connection is received over a USB port. However, other implementations are possible.

The cellular modem 405 provides Internet connectivity to the integrated wireless access device 400 when the wired Internet connection is down or otherwise unavailable. For example, a USB broadband adapter or other cellular modem 405 can be connected to the integrated wireless access device 400 when desired by a user.

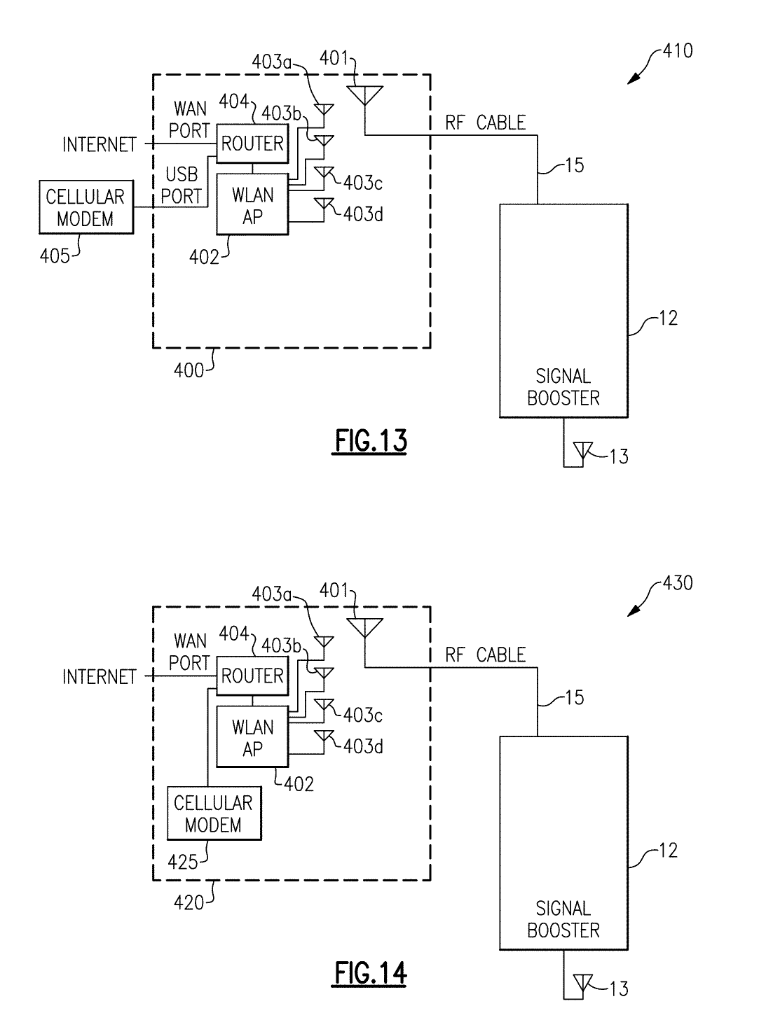

FIG. 14 is a schematic diagram of a cellular and WLAN access system 430 according to another embodiment. The cellular and WLAN access system 430 of FIG. 14 is similar to the cellular and WLAN access system 410 of FIG. 13, except that the cellular and WLAN access system 430 of FIG. 14 includes an integrated wireless access device 420 with an integrated cellular modem 425.

Thus, rather than including a port or other interface for connecting a cellular modem, the integrated wireless access device 420 of FIG. 14 includes a cellular modem 425 that is integrated therein.

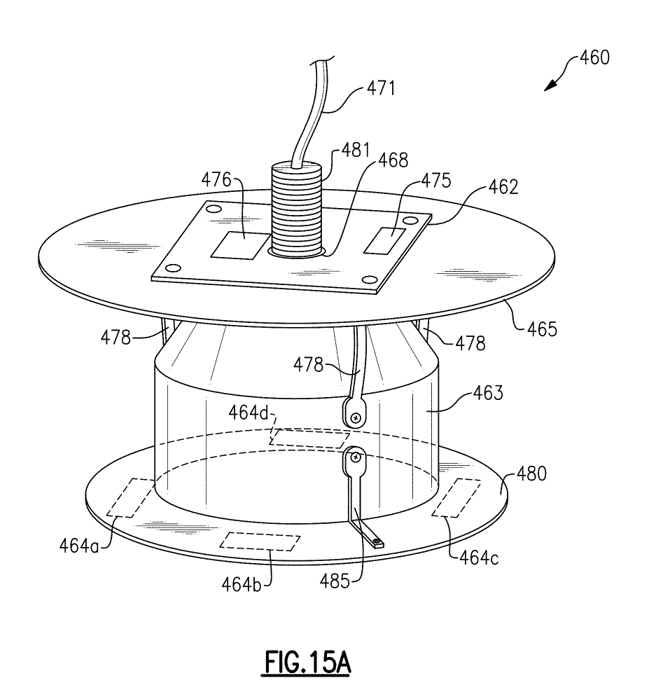

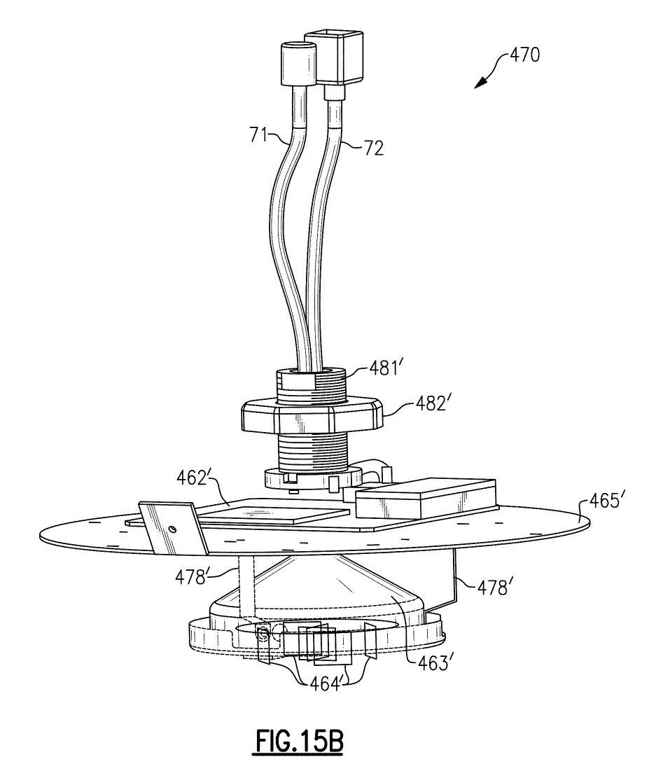

FIG. 15A is a perspective view of an integrated wireless access device 460 with a cover removed, according to another embodiment. The integrated wireless access device 460 includes a cover (not illustrated in FIG. 15A), a circuit board 462, a cellular antenna 463, WLAN antennas 464a-464d (four, in this example), a shielding structure 465, cellular antenna supports 478, an antenna board 480, an antenna board support 485, and a threated tube 481. The circuit board 462 includes WLAN AP circuitry 475 and router circuitry 476. Although not illustrated in FIG. 15A, the housing (including the cover) of the integrated wireless access device 460 can be implemented in a wide variety of ways.

Although one embodiment of an integrated wireless access device is shown in FIG. 15A, the teachings herein are applicable to integrated wireless access devices implemented in a wide variety of ways. For instance, integrated wireless access devices can be implemented with housings of different shapes and/or sizes, with cellular and/or WLAN antennas of different numbers and/or types (for instance, omnidirectional, directional, etc.), with different implementations of circuitry, with different implementations of wiring, and/or in a wide variety of other ways.

In certain implementations, a shielding plate (for instance, the shielding plate 74 of FIG. 3A) is positioned over the circuit board 462, such that both the top and bottom of the circuit board 462 is shielded.

In the illustrated embodiment, the integrated wireless access device 460 receives a combined cable 471 for receiving a DC supply voltage, for communicating signals associated with a wired Internet connection, and for communicating RF cellular signals with a signal booster. The combined cable 471 passes through the threaded pipe 481 to reach circuitry and antennas of the integrated wireless access device 460. Although not illustrated in FIG. 15A, a fastener (for instance, the fastener 82 of FIG. 3A) can operate in combination with the threaded pipe 481 to attach the integrated wireless access device 460 to a roof or wall. However, the teachings herein are applicable to devices installed in other ways.

As shown in FIG. 15A, the circuit board 462 includes a hole 468, which is positioned in about the center of the board, in this example. Including the hole 468 permits passage of wires and/or fasteners, such that the circuit board 462 is compactly stackable together with the cellular antenna 463. For example, conductors or wires associated with the combined cable 471 can pass through the circuit board hole 468 to connect internal circuitry and components of the integrated wireless access device 460.

FIG. 15B is a perspective view of an integrated wireless access device 470 with a cover removed, according to another embodiment.

The integrated wireless access device 470 includes a cover (not illustrated in FIG. 15B), a circuit board 462′, a cellular antenna 463′, WLAN antennas 464′ (four, in this example), a shielding structure 465′, cellular antenna supports 478′, a threated tube 481′, and a fastener 482′. The circuit board 462′ can include any circuitry described herein. Although not illustrated in FIG. 15B, the housing (including the cover) of the integrated wireless access device 470 can be implemented in a wide variety of ways.

In the illustrated embodiment, the WLAN antennas 464′ are attached to (for instance, embedded in) the cellular antenna 463′. Additional details of the integrated wireless access device 470 can be as described above.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled,” as generally used herein, refers to two or more elements that may be either directly connected, or connected by way of one or more intermediate elements Likewise, the word “connected,” as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not only the system described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. An integrated wireless access device for providing cellular and wireless local area network (WLAN) access, the integrated wireless access device comprising:
an antenna operable to wirelessly communicate with user equipment (UE) to provide access to a cellular network;
a housing; and
WLAN access point (AP) circuitry within the housing, wherein the WLAN AP circuitry is configured to control wireless communications with one or more wireless clients of a WLAN network.

2. The integrated wireless access device of claim 1, further comprising an integrated router within the housing and electrically connected to the WLAN AP circuitry.

3. The integrated wireless access device of claim 1, wherein the housing is configured to receive one or more cables, wherein the antenna is operable to transmit a cellular downlink signal received from the one or more cables.

4. The integrated wireless access device of claim 3, wherein the antenna is configured to receive a cellular uplink signal from the UE and to provide the cellular uplink signal to an external signal booster over the one or more cables.

5. The integrated wireless access device of claim 3, wherein the WLAN AP circuitry is operable to receive an Internet connection via the one or more cables.

6. The integrated wireless access device of claim 3, further comprising a circuit board including the WLAN AP circuitry, wherein the circuit board comprises a hole configured for passage of the one or more cables.

7. The integrated wireless access device of claim 3, further comprising a power management circuit within the housing and operable to power the WLAN AP circuitry with a DC supply voltage received from the one or more cables.

8. The integrated wireless access device of claim 3, wherein the one or more cables comprises an Ethernet cable, wherein the integrated wireless access device is powered from the Ethernet cable by Power over Ethernet (POE) technology.

9. The integrated wireless access device of claim 1, wherein the WLAN AP circuitry is configured to control transmission and reception of Wi-Fi signals.

10. The integrated wireless access device of claim 1, wherein the housing includes an interface configured to connect to an external cellular modem, wherein the WLAN AP circuitry is operable to receive an Internet connection via the external cellular modem.

11. The integrated wireless access device of claim 1, further comprising an integrated cellular modem within the housing, wherein the WLAN AP circuitry is operable to receive an Internet connection via the integrated cellular modem.

12. The integrated wireless access device of claim 1, wherein the antenna is further configured to transmit a cellular downlink signal and to receive a cellular uplink signal.

13. The integrated wireless access device of claim 1, wherein the antenna is further configured to transmit a WLAN downlink signal and to receive a WLAN uplink signal.

14. The integrated wireless access device of claim 13, wherein the antenna comprises a wideband antenna operable over at least a frequency range from 698 MHz to 5.9 GHz.

15. The integrated wireless access device of claim 1, further comprising a combiner within the housing, wherein the combiner is operable to combine a cellular signal and a WLAN signal.

16. The integrated wireless access device of claim 1, wherein the WLAN AP circuitry is operable over two or more WLAN frequency bands.

17. The integrated wireless access device of claim 1, further comprising at least one WLAN antenna, wherein the at least one WLAN antenna is operable to transmit a WLAN downlink signal and to receive a WLAN uplink signal.

18. The integrated wireless access device of claim 17, wherein the at least one WLAN antenna comprises two or more WLAN antennas operable to provide multiple-input and multiple-output (MIMO) communications.

19. The integrated wireless access device of claim 1, further comprising a shielding structure positioned between the WLAN AP circuitry and the antenna.

20. The integrated wireless access device of claim 19, further comprising at least one WLAN antenna within the housing, wherein the antenna is positioned within the housing between the shielding structure and the at least one WLAN antenna.

21. The integrated wireless access device of claim 1, wherein the housing comprises at least one of holes or grooves to provide heat dissipation by way of air convection.

22. The integrated wireless access device of claim 1, wherein the WLAN AP circuitry comprises a data exchange circuit, a power amplifier, a low noise amplifier, and a switch.

23. The integrated wireless access device of claim 1, further comprising signal booster circuitry within the housing and configured to boost a cellular uplink signal received from the antenna to generate a boosted cellular uplink signal.

24. The integrated wireless access device of claim 23, wherein the antenna is further configured to transmit a boosted cellular downlink signal received from the signal booster circuitry.

25. The integrated wireless access device of claim 23, wherein the housing is configured to receive one or more cables, wherein the signal booster circuity is further configured to send the boosted cellular uplink signal over the one or more cables.

26. A cellular and wireless local area network (WLAN) access system comprising:
a base station antenna operable to receive a cellular downlink signal;
a signal booster configured to generate a boosted cellular downlink signal by amplifying one or more downlink channels of the cellular downlink signal; and
an integrated wireless access device configured to receive the boosted cellular downlink signal over a radio frequency (RF) cable, the integrated wireless access device comprising:
an antenna configured to transmit the boosted cellular downlink signal and to receive a cellular uplink signal; and
WLAN access point (AP) circuitry configured to control wireless communications over a WLAN network.

27. The cellular and WLAN access system of claim 26, further comprising a router connected to the integrated wireless access device via an Ethernet cable.

28. The cellular and WLAN access system of claim 27, wherein the integrated wireless access device receives power from the Ethernet cable via Power over Ethernet (POE) technology.

29. The cellular and WLAN access system of claim 26, wherein the integrated wireless access device is further configured to provide the cellular uplink signal to the signal booster over the RF cable, wherein the signal booster is further configured to generate a boosted cellular uplink signal by amplifying one or more uplink channels of the cellular uplink signal.

30. The cellular and WLAN access system of claim 26, wherein the integrated wireless access device further comprises at least one WLAN antenna operable to transmit a WLAN transmit signal and to receive a WLAN receive signal.
